(19) United States
(12) Patent Application Publication
(10) Pub. No.: US 2026/0317128 A1
(43) Pub. Date: Oct. 15, 2026

(54) ELEVATOR HOISTING MACHINE AND ELEVATOR APPARATUS

(71) Applicant: Mitsubishi Electric Building Solutions Corporation, Tokyo (JP)

(72) Inventors: Koichi IDA, Tokyo (JP); Hiroki KITANI, Tokyo (JP); Yoshinori TANI, Tokyo (JP); Seiji NISHIDA, Tokyo (JP)

(73) Assignee: Mitsubishi Electric Building Solutions Corporation, Tokyo (JP)

(21) Appl. No.: 19/483,999

(22) PCT Filed: Jul. 4, 2023
(86) PCT No.: PCT/JP2023/024713

§ 371 Date: Nov. 13, 2025

(51) Int. Cl. B66B 11/04

(52) U.S. Cl. CPC B66B 11/0438

(57) ABSTRACT

Provided is an elevator hoisting machine including a housing. The housing includes: a main shaft portion; a connecting portion having a tubular shape, which is connected to the main shaft portion; a bottom plate portion having a flat plate shape, which is connected to the connecting portion; and a stator mounting portion having a tubular shape, which is connected to the bottom plate portion. The rotary body is configured to be mounted to the main shaft portion so as to be rotatable about an axial center of the main shaft portion. A diameter of the connecting portion gradually increases from the main shaft portion toward the bottom plate portion. The bottom plate portion has an opening. The connecting portion is connected to an edge portion of the opening.

### TECHNICAL FIELD

The present disclosure relates to an elevator hoisting machine and an elevator apparatus.

### BACKGROUND ART

In a related-art elevator hoisting machine, a fixed frame body includes a fixed main shaft having a cylindrical shape, a disc portion, and a stator mounting portion. The stator mounting portion is positioned on a radially outer side of the fixed main shaft. The disc portion is provided between the fixed main shaft and the stator mounting portion. Further, the disc portion protrudes radially outward from the fixed main shaft.

The disc portion includes a pair of inclined portions partially formed therein. Each of the inclined portions is inclined with respect to a plane orthogonal to an axis of the fixed main shaft. A fan is mounted on each of the inclined portions (see, for example, Patent Literature 1).

### CITATION LIST

### Patent Literature

[PTL 1] WO 2004/108579 A1

### SUMMARY OF INVENTION

### Technical Problem

In the related-art elevator hoisting machine as described above, a large load is applied to the fixed main shaft during an operation of an elevator apparatus. Thus, a large force is also applied to the disc portion connected to the fixed main shaft. Accordingly, a wall thickness of the disc portion is required to be increased, resulting in an increase in the weight of the fixed frame body.

The present disclosure has been made in order to solve the problem as described above, and has an object to provide an elevator hoisting machine and an elevator apparatus, which allow for a further reduction in the weight of a housing.

### Solution to Problem

According to the present disclosure, there is provided an elevator hoisting machine, including: a housing; a rotary body including a driving sheave, the rotary body being rotatable with respect to the housing; and a hoisting machine motor including: a motor stator configured to be mounted to the housing; and a motor rotor configured to be mounted to the rotary body. The housing includes: a main shaft portion; a connecting portion connected to the main shaft portion; a bottom plate portion having a flat plate shape, which is connected to the connecting portion; and a stator mounting portion having a tubular shape, which is connected to the bottom plate portion. The rotary body is configured to be mounted to the main shaft portion so as to be rotatable about an axial center of the main shaft portion. The connecting portion has a tubular shape. A diameter of the connecting portion gradually increases from the main shaft portion toward the bottom plate portion. The bottom plate portion has an opening. The connecting portion is connected to an edge portion of the opening.

### Advantageous Effects of Invention

According to the present disclosure, the housing of the elevator hoisting machine can be further reduced in weight.

### BRIEF DESCRIPTION OF DRAWINGS

FIG. 1 is a schematic configuration view for illustrating an elevator apparatus according to a first embodiment.

FIG. 2 is a rear view for illustrating an elevator hoisting machine of FIG. 1.

FIG. 3 is a sectional view taken along the line III-III of FIG. 2.

FIG. 4 is a sectional view taken along the line IV-IV of FIG. 2.

FIG. 5 is a front perspective view for illustrating a housing of FIG. 2.

FIG. 6 is a rear perspective view for illustrating the housing of FIG. 2.

FIG. 7 is a rear perspective view for illustrating a housing of an elevator hoisting machine according to a second embodiment.

FIG. 8 is a sectional view of an elevator hoisting machine according to a third embodiment.

### DESCRIPTION OF EMBODIMENTS

Now, embodiments are described with reference to the drawings.

### First Embodiment

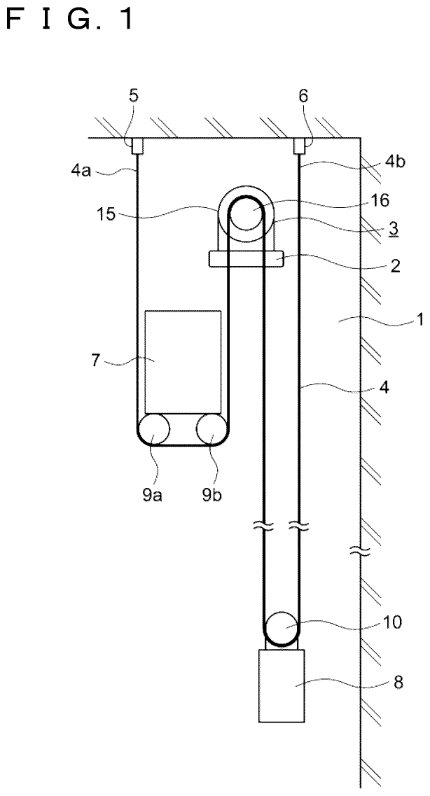

FIG. 1 is a schematic configuration view for illustrating an elevator apparatus according to a first embodiment. In FIG. 1, a machine bed 2 is installed at top of a hoistway 1. An elevator hoisting machine 3 is installed on the machine bed 2.

A suspension body 4 is wound around the elevator hoisting machine 3. A plurality of ropes are used as the suspension body 4.

A first rope stopper 5 and a second rope stopper 6 are provided at the top of the hoistway 1. The suspension body 4 has a first end portion 4a and a second end portion 4b. The first end portion 4a is connected to the first rope stopper 5. The second end portion 4b is connected to the second rope stopper 6.

A car 7 and a counterweight 8 are suspended by the suspension body 4 inside the hoistway 1. A first car suspension sheave 9a and a second car suspension sheave 9b are provided to a lower part of the car 7. A counterweight suspension sheave 10 is provided on top of the counterweight 8.

The suspension body 4 is wound around the first car suspension sheave 9a, the second car suspension sheave 9b, the elevator hoisting machine 3, and the counterweight suspension sheave 10 in the stated order from the first rope stopper 5 side. That is, a roping system used for the elevator apparatus according to the first embodiment is a 2:1 roping system.

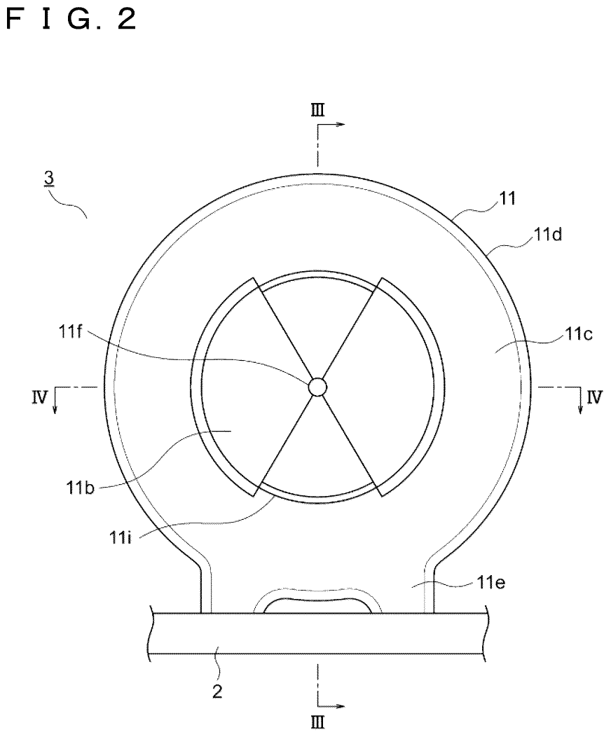

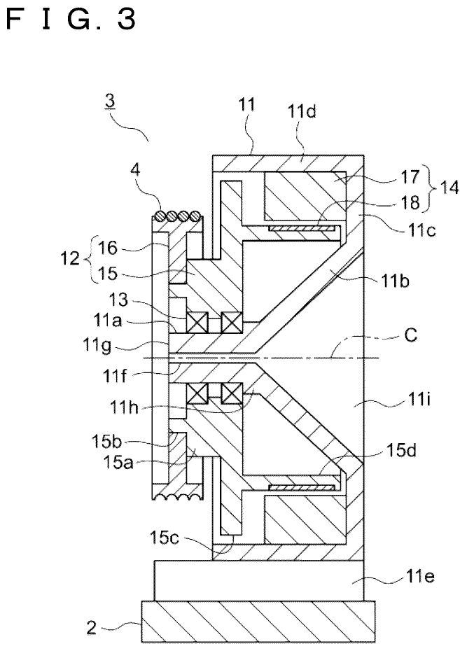

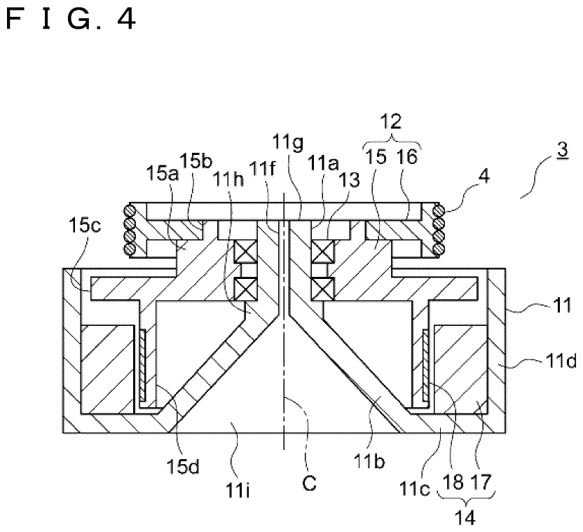

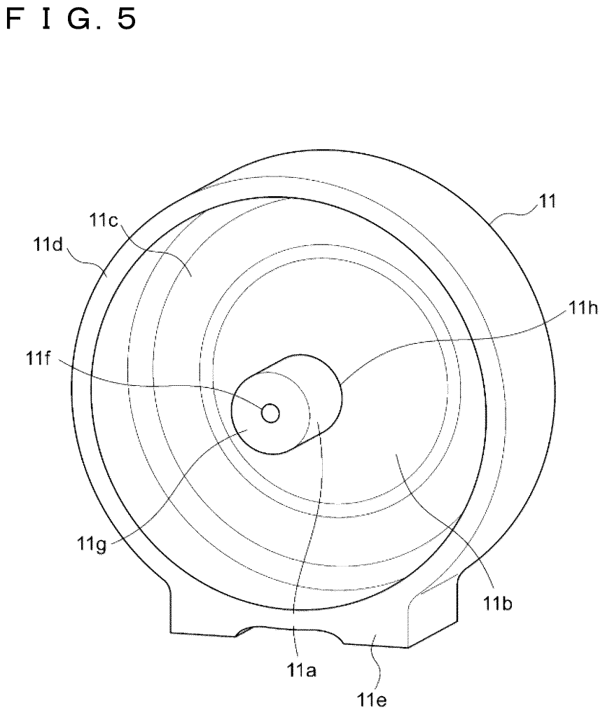

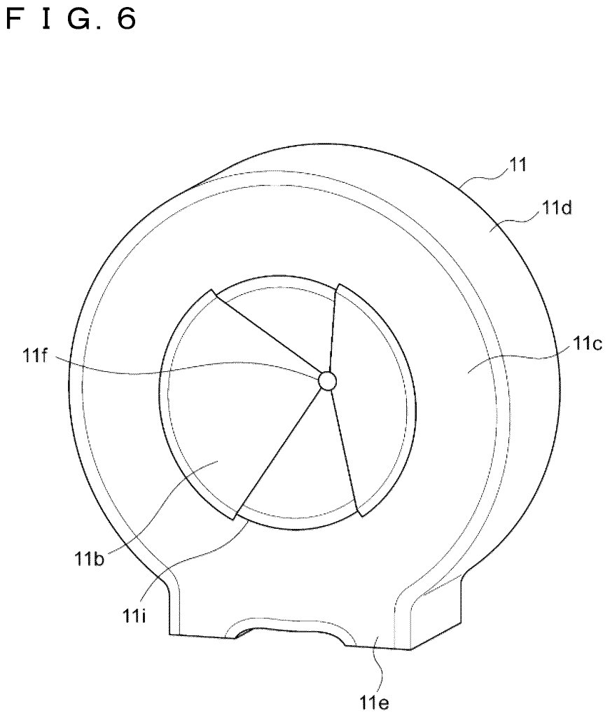

FIG. 2 is a rear view for illustrating the elevator hoisting machine 3 of FIG. 1. FIG. 3 is a sectional view taken along the line III-III of FIG. 2. FIG. 4 is a sectional view taken along the line IV-IV of FIG. 2. FIG. 5 is a front perspective view for illustrating a housing of FIG. 2. FIG. 6 is a rear perspective view for illustrating the housing of FIG. 2.

The elevator hoisting machine 3 includes a housing 11, a rotary body 12, a bearing 13, and a hoisting machine motor 14.

The housing 11 is fixed onto the machine bed 2. Further, the housing 11 includes a main shaft portion 11a having a cylindrical shape, a connecting portion 11b having a tubular shape, a bottom plate portion 11c having a flat plate shape, a stator mounting portion 11d having a cylindrical shape, and leg portions 11e, all of which are formed integrally.

The connecting portion 11b is connected to the main shaft portion 11a. The bottom plate portion 11c is connected to the connecting portion 11b. The stator mounting portion 11d is connected to the bottom plate portion 11c.

The entire housing 11 is formed of the same material. Steel is used as a material for the housing 11. Further, strength of the housing 11 can be increased by using alloyed steel, cast iron, or the like as steel.

An axial center C of the main shaft portion 11a extends horizontally under a state in which the elevator hoisting machine 3 is installed on the machine bed 2. FIG. 3 shows a vertical section of the elevator hoisting machine 3 that includes the axial center C. FIG. 4 shows a horizontal section of the elevator hoisting machine 3 that includes the axial center C.

A through hole 11f is formed along the axial center C in a center of the main shaft portion 11a. The main shaft portion 11a has a first main shaft end 11g and a second main shaft end 11h. The first main shaft end 11g is one end of the main shaft portion 11a in an axial direction of the main shaft portion 11a. The second main shaft end 11h is another end of the main shaft portion 11a in the axial direction of the main shaft portion 11a. The axial direction of the main shaft portion 11a is a direction along the axial center C.

One end of the connecting portion 11b in the axial direction of the main shaft portion 11a is connected directly to the second main shaft end 11h. An opening 11i having a circular shape is formed in the bottom plate portion 11c. Another end of the connecting portion 11b in the axial direction of the main shaft portion 11a is connected directly to an edge portion of the opening 11i. As a result, the bottom plate portion 11c is connected to the main shaft portion 11a with the presence of the connecting portion 11b therebetween.

A diameter of the connecting portion 11b gradually increases from the main shaft portion 11a toward the bottom plate portion 11c. An external shape of the connecting portion 11b in the first embodiment is a shape obtained by removing a vertex portion from a right circular cone. Further, an inclination angle of an outer peripheral surface of the connecting portion 11b with respect to the axial center C in a cross section including the axial center C preferably falls within a range of from 42 degrees to 48 degrees, particularly preferably is 45 degrees.

As illustrated in FIG. 3, a wall thickness of the connecting portion 11b gradually increases toward the bottom plate portion 11c in the vertical section of the housing 11 that includes the axial center C. Further, the wall thickness of the connecting portion 11b in the vertical section of the housing 11 that includes the axial center C is larger than a wall thickness of the connecting portion 11b in the horizontal section of the housing 11 that includes the axial center C.

In FIG. 4, the wall thickness of the connecting portion 11b is the same as a wall thickness of the bottom plate portion 11c. However, the wall thickness of the connecting portion 11b may be smaller than the wall thickness of the bottom plate portion 11c in the horizontal section of the housing 11 that includes the axial center C.

The bottom plate portion 11c is parallel to a plane orthogonal to the axial center C. The stator mounting portion 11d is connected to the connecting portion 11b with the presence of the bottom plate portion 11c therebetween. The leg portions 11e are formed at a lower end of the stator mounting portion 11d. Further, the leg portions 11e are fixed to the machine bed 2.

The rotary body 12 includes a rotary member 15 and a driving sheave 16. The rotary member 15 is mounted over the main shaft portion 11a so as to be rotatable about the axial center C through intermediation of the bearing 13. That is, the rotary body 12 is supported by the main shaft portion 11a and is rotatable with respect to the housing 11.

The rotary member 15 includes a bearing holding portion 15a having a cylindrical shape, a sheave fixed portion 15b having a cylindrical shape, a braked portion 15c having a disc shape, and a rotor mounting portion 15d having a cylindrical shape, all of which are formed integrally.

The bearing 13 is held on an inner side of the bearing holding portion 15a. The sheave fixed portion 15b protrudes, in parallel to the axial center C, from the bearing holding portion 15a to a side opposite to the bottom plate portion 11c and the connecting portion 11b.

The braked portion 15c protrudes from an outer peripheral surface of the bearing holding portion 15a to a radially outer side of the bearing holding portion 15a. A radial direction of the bearing holding portion 15a is a direction orthogonal to the axial center C. A brake shoe of a hoisting machine brake (not shown) is pressed against the braked portion 15c. In this manner, the rotary body 12 is held in a stationary state.

The rotor mounting portion 15d protrudes, in parallel to the axial center C, from the braked portion 15c toward the bottom plate portion 11c.

The driving sheave 16 is fitted over the sheave fixed portion 15b and is fixed thereto. Thus, the driving sheave 16 is rotated together with the rotary member 15. The suspension body 4 is wound around the driving sheave 16. The car 7 and the counterweight 8 are raised and lowered inside the hoistway 1 by rotating the driving sheave 16.

The hoisting machine motor 14 causes the rotary body 12 to rotate. Further, the hoisting machine motor 14 includes a motor stator 17 and a motor rotor 18.

The motor stator 17 is mounted to an inner peripheral surface of the stator mounting portion 11d. Further, the motor stator 17 has a plurality of coils. In FIG. 3 and FIG. 4, a specific configuration of the motor stator 17 is omitted.

The motor rotor 18 is mounted over the rotor mounting portion 15d. Further, the motor rotor 18 is opposed to the motor stator 17. Further, the motor rotor 18 includes a plurality of magnets.

In the elevator hoisting machine 3 and the elevator apparatus as described above, the housing 11 includes the main shaft portion 11a, the connecting portion 11b, the bottom plate portion 11c, and the stator mounting portion 11d. Thus, the number of components is less than that of components used in a configuration in which a main shaft, which is a separate member from a housing, is mounted to the housing. As a result, the number of assembly steps can be reduced.

Further, a load, which is otherwise applied when the main shaft is fitted into the housing, is not applied, and hence stress is not concentrated on a fitting portion. Thus, a wall thickness of the housing 11 is not particularly required to be increased, thus allowing for a reduction in the weight of the housing 11. In this manner, the elevator hoisting machine 3 can be reduced in weight.

Further, the connecting portion 11b is connected to the edge portion of the opening 11i of the bottom plate portion 11c. Further, the bottom plate portion 11c is connected to the main shaft portion 11a with the presence of the connecting portion 11b therebetween. The connecting portion 11b has a tubular shape, and the diameter of the connecting portion 11b gradually increases from the main shaft portion 11a toward the bottom plate portion 11c.

This allows a bending load applied to the main shaft portion 11a to be received by the entire housing 11 in an efficiently and effectively distributed manner. Thus, the wall thickness of the housing 11 can be reduced, allowing for a further reduction in the weight of the housing 11.

Further, the stiffness of the housing 11 can be increased, thus reducing or preventing deflection of the portions of the housing 11. As a result, deflection and deformation of the components mounted to the housing 11, that is, the motor stator 17, the bearing 13, and the rotary body 12 can be reduced or prevented. Accordingly, loss in the elevator hoisting machine 3 can be reduced, thus improving performance of the elevator hoisting machine 3.

Further, the external shape of the connecting portion 11b is a right circular cone. Thus, stress generated in the housing 11 can be more efficiently distributed and reduced.

Further, when the inclination angle of the outer peripheral surface of the connecting portion 11b with respect to the axial center C is set to fall within the range of from 42 degrees to 48 degrees, the stress generated in the housing 11 can be more reliably reduced, allowing for a further reduction in the weight of the housing 11. In particular, when the inclination angle is set to 45 degrees, the stress generated in the housing 11 can be minimized.

Further, when the wall thickness of the connecting portion 11b is set smaller than the wall thickness of the bottom plate portion 11c in the horizontal section of the housing 11 that includes the axial center C, the housing 11 can be further reduced in weight. Further, a section modulus, a moment of inertia of area, and the like can be more efficiently and effectively maintained against the load applied to the main shaft portion 11a, and hence the load applied to the main shaft portion 11a can be efficiently borne by the entire housing 11.

Further, the wall thickness of the connecting portion 11b gradually increases toward the bottom plate portion 11c in the vertical section of the housing 11 that includes the axial center C. As a result, the housing 11 can be reduced in weight, while the strength of the housing 11 is increased.

### Second Embodiment

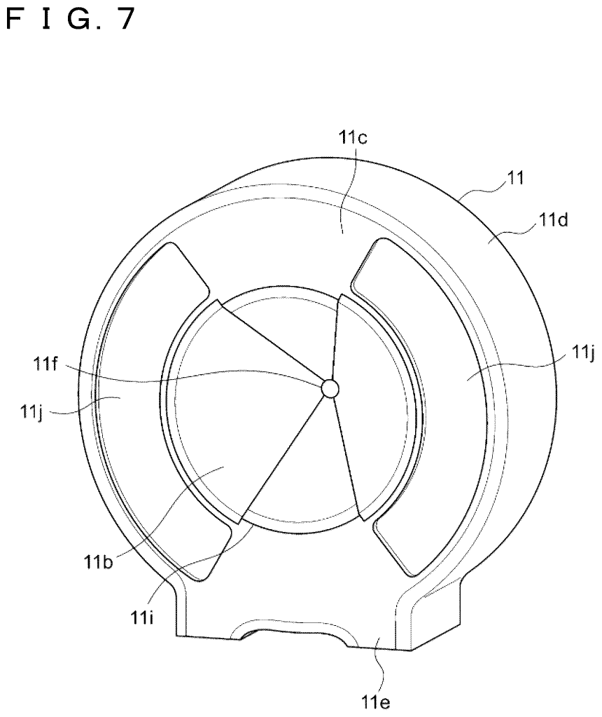

Next, FIG. 7 is a rear perspective view for illustrating a housing 11 of an elevator hoisting machine 3 according to a second embodiment. In the second embodiment, a pair of recessed portions 11j are formed in a bottom plate portion 11c. The pair of recessed portions 11j are formed in an end surface of the bottom plate portion 11c in a direction parallel to an axial center C, which is included in an outer surface of the bottom plate portion 11c. Further, the pair of recessed portions 11j are formed in the bottom plate portion 11c on both of right and left sides of a connecting portion 11b.

Thus, a wall thickness of the bottom plate portion 11c in a horizontal section of the housing 11 that includes the axial center C is smaller than a wall thickness of the bottom plate portion 11c in a vertical section of the housing 11 that includes the axial center C. That is, the wall thickness of the bottom plate portion 11c on right and left sides of the connecting portion 11b is smaller than the wall thickness of the bottom plate portion 11c on upper and lower sides of the connecting portion 11b.

Other configurations in the second embodiment are the same as those in the first embodiment.

Also the configuration as described above allows the same effects as those of the first embodiment to be obtained. Further, the wall thickness of the bottom plate portion 11c is set smaller on the right and left sides of the connecting portion 11b, allowing for a further reduction in the weight of the housing 11.

Further, the wall thickness of the bottom plate portion 11c is set larger on the upper and lower sides of the connecting portion 11b. Thus, areas of the bottom plate portion 11c on the upper and lower sides of the connecting portion 11b function as ribs. Accordingly, a section modulus, a moment of inertia of area, and the like can be more efficiently and effectively maintained against the load applied to the main shaft portion 11a, and hence the load applied to the main shaft portion 11a can be efficiently borne by the entire housing 11.

### Third Embodiment

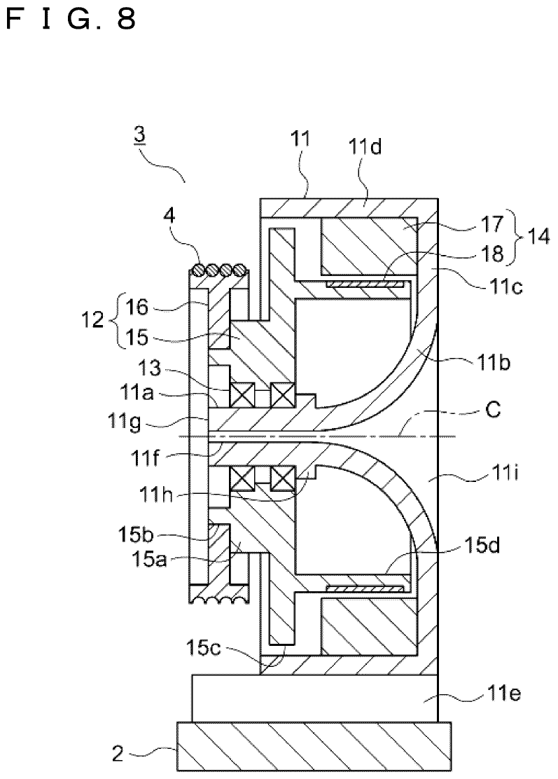

Next, FIG. 8 is a sectional view of an elevator hoisting machine 3 according to a third embodiment, for illustrating a vertical section of the elevator hoisting machine 3 that includes an axial center C. In the third embodiment, a connecting portion 11b is curved with a constant curvature so as to be convex inward of the connecting portion 11b.

Other configurations in the third embodiment are the same as those in the first embodiment.

Also the configuration as described above allows the Same effects as those of the first embodiment to be obtained. Further, a load applied to a main shaft portion 11a can be more efficiently and effectively distributed to an entire housing 11. Thus, the housing 11 can be further reduced in weight while maintaining sufficient strength.

Recessed portions 11j similar to those of the second embodiment may be formed in the housing 11 according to the third embodiment.

Further, in the first to third embodiments, the suspension body 4 may be a plurality of belts.

Further, the type of elevator apparatus is not limited to the type as shown in FIG. 1, and may be, for example, a 1:1 roping system. Further, the elevator hoisting machine 3 may be installed at a position other than at the top of the hoistway 1.

Further, the elevator apparatus may be an elevator apparatus with a machine room, a double-deck elevator, a single-shaft multicar system elevator, or the like. The single-shaft multicar system is a system in which an upper car and a lower car that is arranged directly below the upper car are raised and lowered independently of each other in a common hoistway.

### REFERENCE SIGNS LIST

3 elevator hoisting machine, 11 housing, 11a main shaft portion, 11b connecting portion, 11c bottom plate portion, 11d stator mounting portion, 11i opening, 12 rotary body, 14 hoisting machine motor, 16 driving sheave, 17 motor stator, 18 motor rotor

1. An elevator hoisting machine, comprising:
a housing;
a rotary body including a driving sheave, the rotary body being rotatable with respect to the housing; and
a hoisting machine motor including:
a motor stator configured to be mounted to the housing; and
a motor rotor configured to be mounted to the rotary body,
wherein the housing includes:
a main shaft portion;
a connecting portion connected to the main shaft portion;
a bottom plate portion having a flat plate shape, which is connected to the connecting portion; and
a stator mounting portion having a tubular shape, which is connected to the bottom plate portion,
wherein the rotary body is configured to be mounted to the main shaft portion so as to be rotatable about an axial center of the main shaft portion,
wherein the connecting portion has a tubular shape,
wherein a diameter of the connecting portion gradually increases from the main shaft portion toward the bottom plate portion,
wherein the bottom plate portion has an opening, and
wherein the connecting portion is connected to an edge portion of the opening.

2. The elevator hoisting machine according to claim 1, wherein a wall thickness of the connecting portion is smaller than a wall thickness of the bottom plate portion in a horizontal section of the housing that includes the axial center.

3. The elevator hoisting machine according to claim 1, wherein a wall thickness of the connecting portion gradually increases toward the bottom plate portion in a vertical section of the housing that includes the axial center.

4. The elevator hoisting machine according to claim 1, wherein a wall thickness of the bottom plate portion in a horizontal section of the housing that includes the axial center is smaller than a wall thickness of the bottom plate portion in a vertical section of the housing that includes the axial center of the main shaft portion.

5. The elevator hoisting machine according to claim 1, wherein the connecting portion is curved so as to be convex inward of the connecting portion.

6. An elevator apparatus, comprising the elevator hoisting machine of claim 1.

7. The elevator hoisting machine according to claim 2, wherein a wall thickness of the connecting portion gradually increases toward the bottom plate portion in a vertical section of the housing that includes the axial center.

8. The elevator hoisting machine according to claim 2, wherein a wall thickness of the bottom plate portion in a horizontal section of the housing that includes the axial center is smaller than a wall thickness of the bottom plate portion in a vertical section of the housing that includes the axial center of the main shaft portion.

9. The elevator hoisting machine according to claim 3, wherein a wall thickness of the bottom plate portion in a horizontal section of the housing that includes the axial center is smaller than a wall thickness of the bottom plate portion in a vertical section of the housing that includes the axial center of the main shaft portion.

10. The elevator hoisting machine according to claim 7, wherein a wall thickness of the bottom plate portion in a horizontal section of the housing that includes the axial center is smaller than a wall thickness of the bottom plate portion in a vertical section of the housing that includes the axial center of the main shaft portion.
